(19) United States
(12) Patent Application Publication
(10) Pub. No.: US 2012/0305526 A1
(43) Pub. Date: Dec. 6, 2012

(54) METHOD OF WET ETCHING SUBSTRATES FOR FORMING THROUGH HOLES TO EMBED WAFER LEVEL OPTICAL LENS MODULES

(75) Inventor: Cheng-Heng Chen, Tainan City (TW)

(73) Assignee: HIMAX TECHNOLOGIES LIMITED, Tainan City (TW)

(21) Appl. No.: 13/152,610

(22) Filed: Jun. 3, 2011

(51) Int. Cl. C23F 1/02; C03C 15/00; C23F 1/16

(52) U.S. Cl. 216/41

(57) ABSTRACT

A method of wet etching substrates for forming through holes to embed wafer level optical lens modules is provided. The provided etching method is capable of concurrently etching a plurality of substrates to form the through holes since bidirectional etching process is used. That means, all the desired through holes can be formed simultaneously during the wet etching process. Additionally, a plurality of substrates can be etched by each run of etching process. Thus, the newly provided wet etching method significantly and effectively reduces the process time and manufacturing cost.

### BACKGROUND OF THE INVENTION

1. Field of the Invention

The present invention generally relates to wafer level optical spacers and more particularly to a process improvement of wafer level optical spacers.

2. Description of Related Art

With the trend of miniaturizing modules and reducing prices of electronic products, the launch of the wafer level module technology has gained more attention. The wafer level module technology mainly adopts wafer level fabrication technique in electronic products to miniaturize volumes of electronic products and reduce fabrication costs. The wafer level module technology is also applied in the fabrication of wafer level optical lens modules, such that volumes of wafer level optical lens modules can be greatly reduced comparing to that of conventional lens modules. Wafer level optical lens modules are consequently utilized in camera modules of cellular phones, for example.

FIG. 1A is a top view schematically illustrating a portion of a conventional wafer level optical lens module. FIG. 1B is a cross-sectional view illustrating the portion of the wafer level optical lens module depicted in FIG. 1A taken along a sectional line AA′. Referring to FIG. 1A and FIG. 1B simultaneously, a conventional wafer level optical lens module 100 at least includes a lens substrate 110, a first spacer layer 120, a second spacer layer 130, and a pair of substrates 142, 144. The lens substrate 110 has a transparent substrate 112 and at least one lens 114 disposed on both sides of the transparent substrate 112. The lens substrate 110 is located between the pair of substrates 142, 144. The first spacer layer 120 is located between the substrate 142 and the transparent substrate 112 to maintain a first space S1. Moreover, the second spacer layer 130 is located between the substrate 144 and the transparent substrate 112 to maintain a second space S2. The lens 114 is located between the first space S1 and the second space S2, as shown in FIG. 1B.

In the wafer level optical lens module, it has to form through holes in the spacer layers in order to embed the at least one wafer level optical lens within the spacers. Glass materials are commonly used in forming spacers nowadays. FIG. 2 illustrates a conventional method of manufacturing spacers for wafer level optimal lens modules, wherein merely one through hole for embedding one wafer level optimal lens module can be drilled and merely one glass substrate can be conducted by each run of laser drilling process. Specifically, as shown in FIG. 2, the glass substrate 200 is used to form the spacers of the wafer level optical lens modules. A plurality of through holes 201 have to be formed on the glass substrates 200. During the conventional laser drilling process, the through holes 201 are drilled merely one after one on the glass substrate 200. Furthermore, merely one glass substrate 200 can be conducted by each run of laser drilling process. Thus, the conventional laser drilling process used to form spacers in the manufacturing of wafer level optical lens modules is a rather time consuming and tedious process and it is not quite cost effective.

### SUMMARY OF THE INVENTION

The present invention is directed to a method of wet etching substrates for forming through holes to embed wafer level optical lens modules.

The present invention provides a method of wet etching substrates for forming through holes to embed wafer level optical lens modules. According to an embodiment of present invention, the steps of the wet etching method are as follows. First, a plurality of substrates are provided and each of the substrates is sheltered with a mask to form a plurality of sheltered substrates. Then, an etchant is provided in an etching bath. After that, the sheltered substrates are immersed within the etchant for a predetermined time period to form a plurality of etched substrates. Herein, each of the etched substrates has a plurality of through holes capable of embedding a plurality of wafer level optical lens modules.

According to an embodiment of the present invention, at least two opposite surfaces of each of the substrates are etched during the predetermined time period.

According to an embodiment of the present invention, a gap exists between each two substrates.

According to an embodiment of the present invention, the etching bath has a plurality of trenches at the bottom, and each of the trenches accommodates a portion of each of the substrates.

According to an embodiment of the present invention, the substrate is a glass substrate to be used as spacers for the wafer level optical lens modules.

According to an embodiment of the present invention, the etchant includes a hydrofluoric acid (HF).

According to an embodiment of the present invention, the number of the substrates is equal to or greater than ten for each process run.

According to an embodiment of the present invention, each of the masks has a predetermined pattern which exposes portions of the substrates to be etched and covers other portions of the substrate not to be etched.

According to an embodiment of the present invention, the method further includes removing each of the masks of the etched substrates and cleaning each of the etched substrates.

According to an embodiment of the present invention, the method further includes heating the etchant after the etchant is provided in the etching bath.

In view of the above, according to the embodiments of the present invention, a plurality of through holes are formed on the glass substrates simultaneously through the method of wet etching substrates. In addition, the provided wet etching method is a kind of bidirectional wet etching method and thus capable of concurrently etching a plurality of glass substrates by each run of etching process. Thus, the newly provided wet etching method significantly and effectively reduces the process time and manufacturing cost.

In order to make the above features and advantages of the present invention comprehensible, embodiments are described in detail below with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a top view schematically illustrating a portion of a conventional wafer level optical lens module.

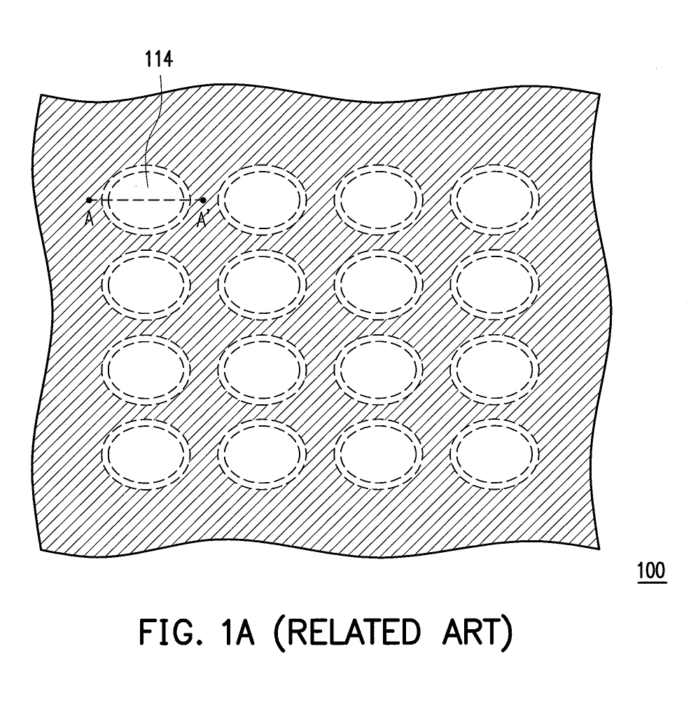

FIG. 1B is a cross-sectional view illustrating the portion of the wafer level optical lens module depicted in FIG. 1A taken along a sectional line AA′.

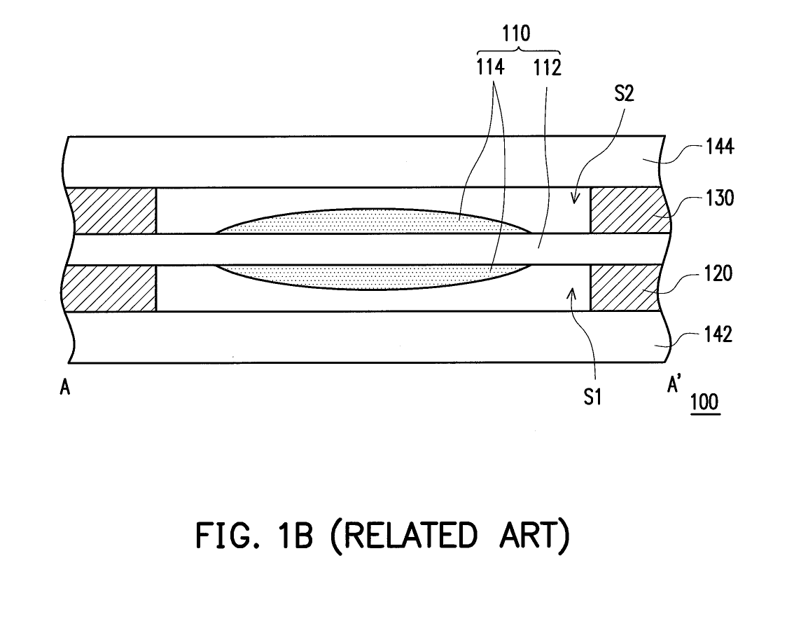

FIG. 2 illustrates a conventional method of manufacturing spacers for wafer level optimal lens modules.

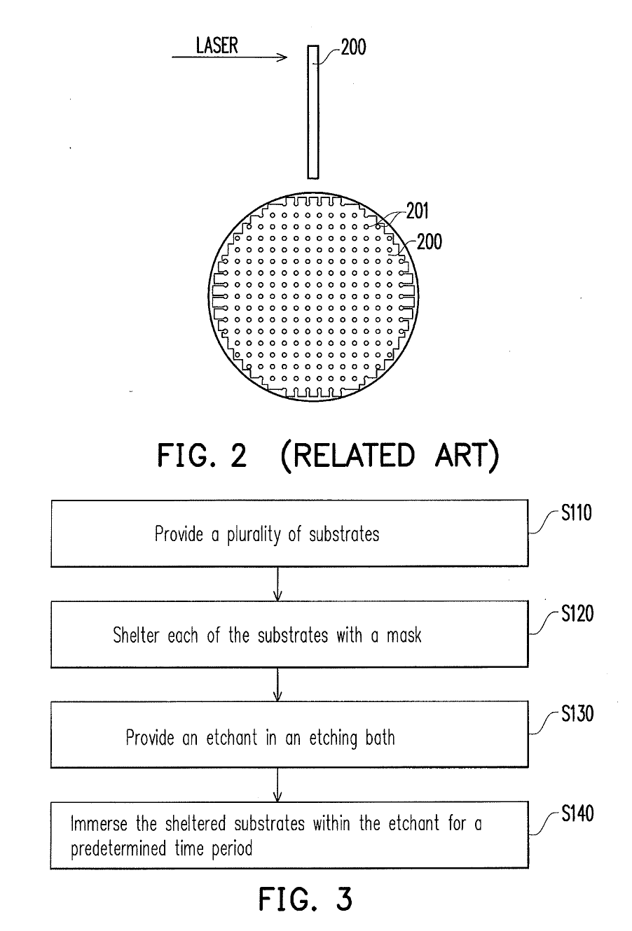

FIG. 3 is a flow chart illustrating a wet etching method of substrates for forming a plurality of through holes to embed wafer level optical lens modules according to an embodiment of present invention.

FIG. 4A to 4E schematically illustrate the wet etching method of substrates of FIG. 3 in which a plurality of through holes are concurrently formed and a plurality of substrates are simultaneously conducted by each run.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The figures are not drawn to scale and they are provided merely to illustrate the present invention. Several aspects of the invention are described below with reference to example applications for illustration. It should be understood that numerous specific details, relationships and methods are set forth to provide a full understanding of the invention. The present invention may be embodied in many different forms and should not be construed as limited to the embodiments set forth herein. For example, the present invention can be embodied as a method or a system.

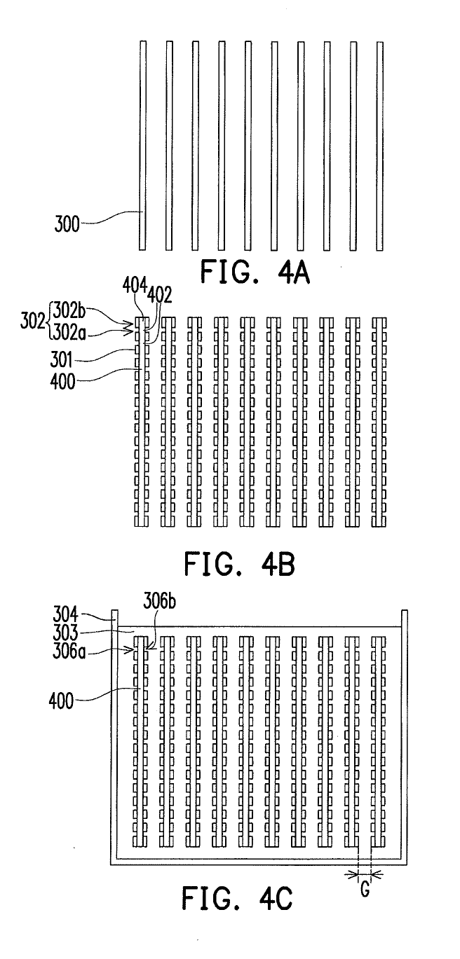

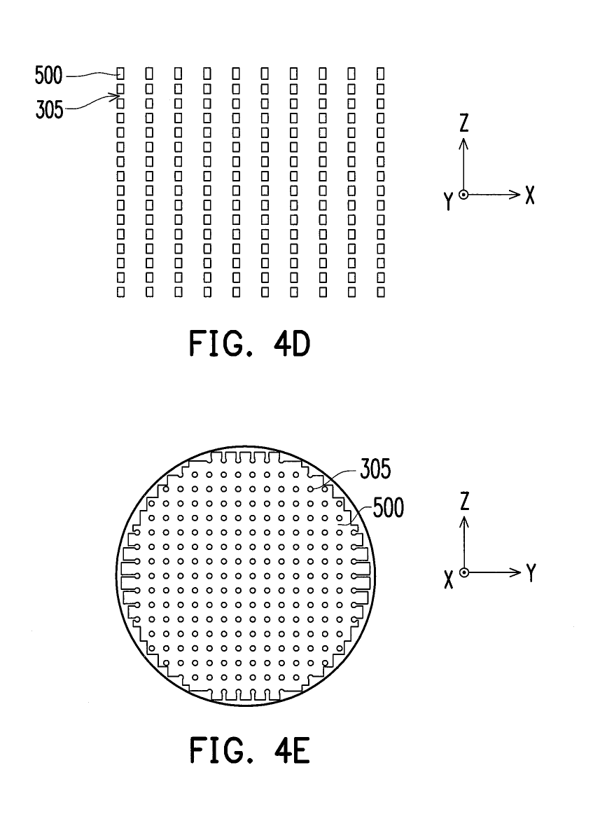

The present invention provides a method of wet etching substrates for forming through holes to embed wafer level optical lens modules. FIG. 3 is a flow chart illustrating a wet etching method of substrates for forming a plurality of through holes to embed wafer level optical lens modules according to an embodiment of present invention. FIG. 4A to 4E schematically illustrate the wet etching method of substrates of FIG. 3 in which a plurality of through holes are concurrently formed and a plurality of substrates are simultaneously conducted by each run. Referring to FIG. 3 and FIG. 4A to 4E, the steps of the wet etching method are as follows. First, a plurality of substrates 300 are provided as shown in FIG. 4A (step S1). Then, referring to FIG. 4B, each of the substrates 300 is sheltered with a mask 301 to form a plurality of sheltered substrates 400 (step S2). Herein, the mask 301 of the embodiment is capable of being removed after etching. In the embodiment, the mask 301 has a predetermined pattern 302 to form the through holes on the substrates. Specifically, each of the predetermined patterns 302 exposes portions of the substrate 400 to be etched 302a and covers other portions of the substrate 400 not to be etched 302b. Then, an etchant 303 is provided in an etching bath 304 (step S3). After that, as shown in FIG. 4C and 4D, the sheltered substrates 400 are immersed within the etchant 303 for a predetermined time period to form a plurality of etched substrates 500 (step S4). In this way, the wet etching process is completed. Furthermore, since the sheltered substrates 400 are immersed within the etchant 303, at least two opposite surfaces 306a [symbol] 306b of each of the substrates 400 are etched during the predetermined time period. Hence, the wet etching method of the embodiment is a bidirectional wet etching method. And in order to facilitate the bidirectional wet etching method, the substrates 400 are, for example, arranged in the etching bath with a gap G existing between each two adjacent substrates 400. Moreover, to ensure the stability of the substrates positions during etching process, the etching bath may, for example, have a plurality of trenches (not shown) at the bottom, and each of the trenches accommodates a portion of each of the substrates 400.

After step S4, the wet etching method of the embodiment may further include removing each of the masks 301 of the etched substrates 500 and cleaning each of the etched substrates 500. Then, as shown in FIG. 4D and 4E, each of the etched substrates 500 has a plurality of through holes 305 capable of embedding a plurality of wafer level optical lens modules.

Referring to FIG. 3 and FIG. 4A to FIG. 4E, during the wet etching method according to the above mentioned embodiment of present invention, a plurality of substrates 300 can be conducted by each run. For example, the number of the substrates 300 used in every run of etching process is equal to or greater than ten. In the embodiment, ten substrates are used in the etching process as an example. Besides, a plurality of through holes 305 are concurrently formed on each of the substrates 500 by each run of wet etching process. Moreover, since the substrate 500 of FIG. 4E is to be used as spacers for wafer level optical lens modules, a glass substrate is used in the embodiment. In some embodiments, the quantity and concentration of the etchant 303 can be adjusted to meet the desired etching speed and quality by the user, and the present invention is not limited thereto. Besides, the predetermined pattern 302 of the mask 301 can also be selected by the user according to the desired number and required locations of through holes 305 going to form on the glass substrate. In some embodiment, thousands of through holes 305 can be conducted by each run of wet etching process.

In some embodiments, during the wet etching process, generating bubbles using a gas, such as nitrogen (N2), oxygen (02) or any other gases appropriate, may be conducted to improve the etching quality. Hydrofluoric acid (HF) is most commonly used to etch glass material and thus, the embodiment of present invention mainly uses hydrofluoric acid in the wet etching process. Certainly, one or more sorts of appropriate catalysts are used to complete or speed up the etching process in present invention, and the present invention is not limited thereto. In some embodiments of present invention, the etchant 303 can be heated to a certain temperature after the etchant 303 is provided in the etchant bath 304 so that the etching is an exothermic reaction and enhance the quality of etching.

In view of the above, according to the embodiments of the present invention, a plurality of through holes are formed on the substrates simultaneously. In addition, the provided wet etching method is a kind of bidirectional wet etching method and thus capable of concurrently etching a plurality of substrates by each run of etching process. The provided wet etching method is much faster than the conventional laser drilling process. Thus, the newly provided wet etching method significantly and effectively reduces the process time and manufacturing cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of wet etching substrates for forming through holes to embed wafer level optical lens modules, comprising:
providing a plurality of substrates;
sheltering each of the substrates with a mask to form a sheltered substrate;
providing an etchant in an etching bath; and
immersing the sheltered substrates within the etchant for a predetermined time period to form a plurality of etched substrates, wherein each of the etched substrates has a plurality of through holes capable of embedding a plurality of wafer level optical lens modules.

2. The method according to claim 1, wherein at least two opposite surfaces of each of the substrates are etched during the predetermined time period.

3. The method according to claim 2, wherein a gap exists between each two substrates.

4. The method according to claim 3, wherein the etching bath has a plurality of trenches at the bottom, and each of the trenches accommodates a portion of each of the substrates.

5. The method according to claim 1, wherein the substrate is a glass substrate to be used as spacers for the wafer level optical lens modules.

6. The method according to claim 1, wherein the etchant comprises a hydrofluoric acid.

7. The method according to claim 1, wherein the number of the substrates is equal to or greater than ten.

8. The method according to claim 1, wherein each of the masks has a predetermined pattern which exposes portions of the substrate to be etched and covers other portions of the substrate not to be etched.

9. The method according to claim 1, further comprising:
removing each of the masks of the etched substrates; and
cleaning each of the etched substrates.

10. The method according to claim 1, further comprising: heating the etchant after the etchant is provided in the etching bath.
